(19) United States
(12) Patent Application Publication
(10) Pub. No.: US 2007/0181216 A1
(43) Pub. Date: Aug. 9, 2007

(54) Device for the handling of logs

(76) Inventor: Stefano Petri, Capannori (Lucca) (IT)

Correspondence Address: MCGLEW & TUTTLE, PC, P.O. BOX 9227, SCARBOROUGH STATION, SCARBOROUGH, NY, 10510-9227, US

(21) Appl. No.: 10/599,120

(22) PCT Filed: Mar. 22, 2005
(86) PCT No.: PCT/IT05/00151

§ 371 Date: Sep. 20, 2006

(30) Foreign Application Priority Data
Apr. 7, 2004 (IT) FI2004A000084

(51) Int. Cl. B27C 9/00; B27M 3/00; B27M 1/08; B27L 9/00; B27L 3/00; B27L 5/00

(52) U.S. Cl. 144/2.1; 144/3.1; 144/1.1

(57) ABSTRACT

Device for the handling of logs, especially within a trimming machine, being comprised of handling means for logs along a path developed between the entrance section (I) of the logs (3) to be trimmed and the exit section (U) of the trimmed logs (3′), with blades (10, 11) set along said path and intended to provide the trimming of the logs (3), the entire device being characterized in that said handling means of logs also constitute means of holding or blocking the logs along said path.

The present invention relates to a device for the handling of logs, and more in particular for the handling of logs during the trimming of the same.

It is known that a log is made of web-like material wound around a tubular core made of cardboard or similar material. It is also known that logs are formed by “rewinding” machines, downstream from which usually there are a storage unit for logs and, further still, one or more cutting machines. The latter cut the logs into shorter units, that is into retail size rolls, for example into toilet tissue rolls. A so-called “trimming” is provided since, after the rewinding phase, the logs are never perfectly cylindrical, meaning that the two extremities of each rewound log are never perfectly orthogonal to the longitudinal axis of the log. Such operation, which may be provided before the logs enter the cutting machines or within the operational area of the same, consists of the removal of reduced amounts of material from each log in correspondence of each extremity by means of two simultaneous cuts made by blades cutting the log as it is transported.

In order to obtain an effective trimming, it is necessary to ensure a functional handling of the logs, the lack of which would result in imprecise cuts made in correspondence of each extremity.

The main objective of the present invention is to provide a device that ensures the most effective handling of the logs to be trimmed.

This result has been achieved, according to the invention, by adopting the idea of making a device having the characteristics disclosed in claim 1. Further characteristics of the present invention are dealt with in the dependent claims.

Thanks to the present invention, logs, of any diameter, are effectively handled and guided during the trimming phase, therefore maximizing the precision of the trimming operation. Moreover, a device according to the invention is easy to make, cost-effective and still reliable after extended use.

These and other advantages and characteristics of the invention will be best understood by anyone skilled in the art from a reading of the following description in conjunction with the attached drawings given as a practical exemplification of the invention, but not to be considered in a limitative sense, wherein:

FIG. l is a schematic rear-lateral perspective of a device according to the invention;

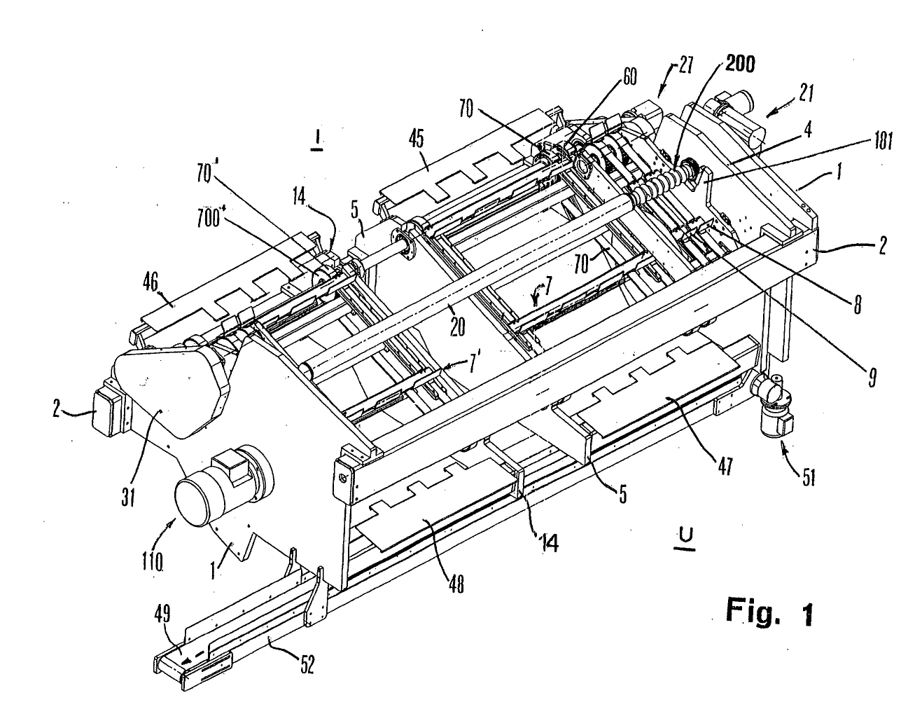

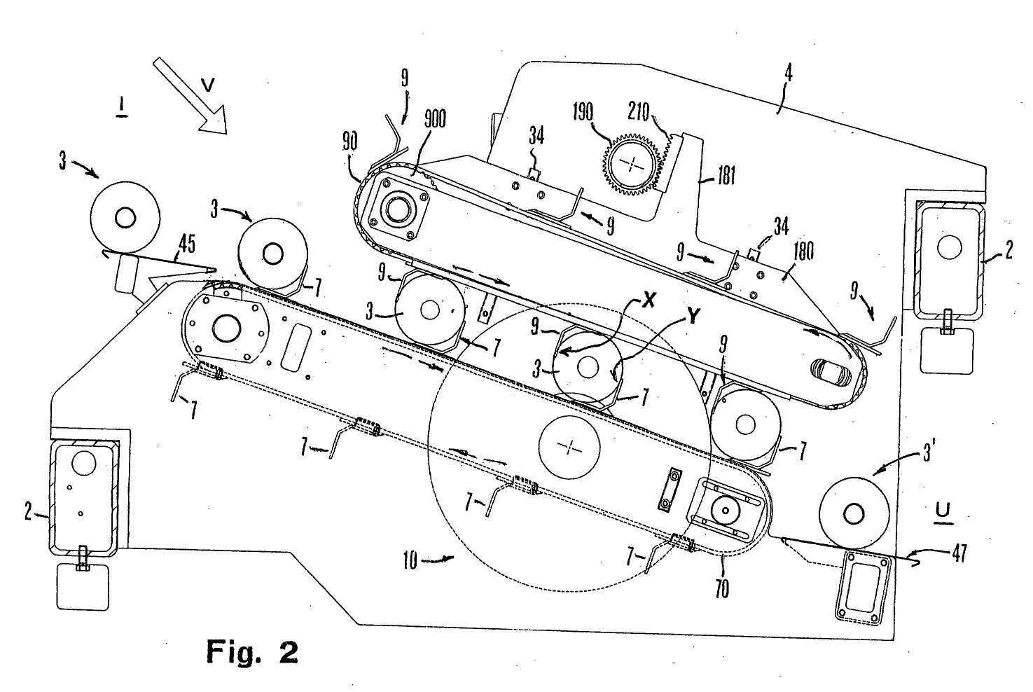

FIG. 2 is a schematic internal left-side perspective of the device in FIG. 1;

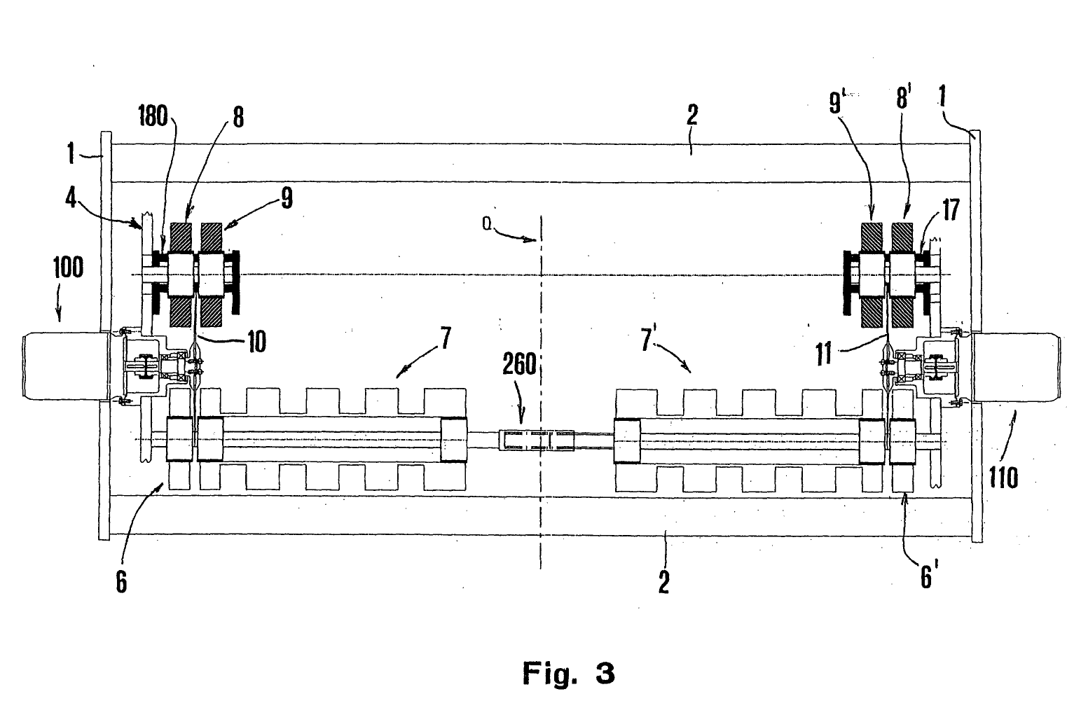

FIG. 3 is a simplified schematic perspective from “V” of the device shown in FIG. 2, intended to illustrate, in detail, the position of the cutting blades and their respective motors;

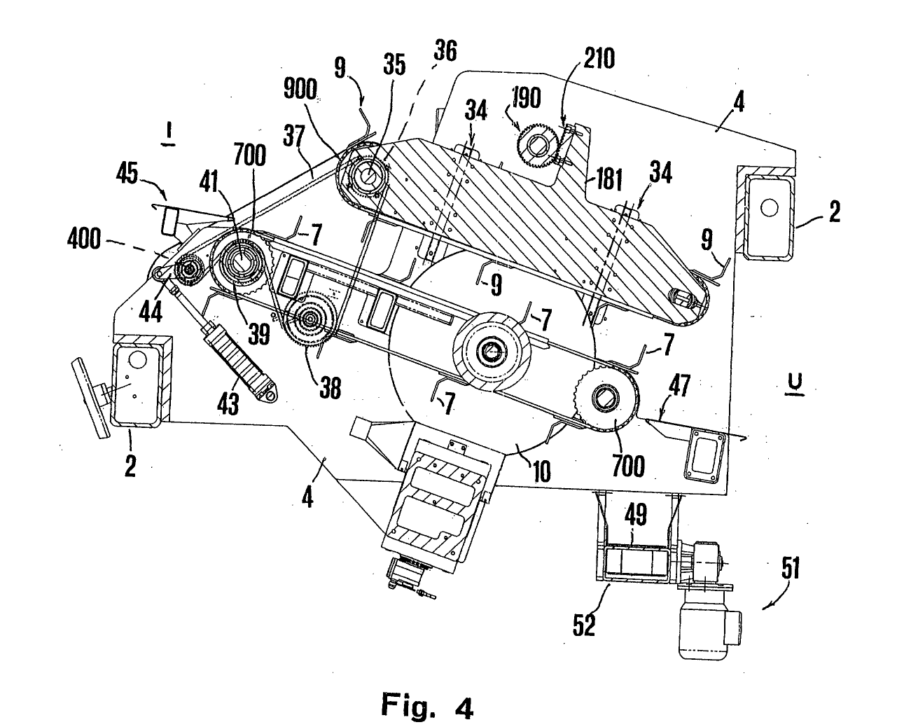

FIG. 4 is a perspective analogous to FIG. 2, providing further details of the handling mechanism with a guide blade-equipped conveyor belt;

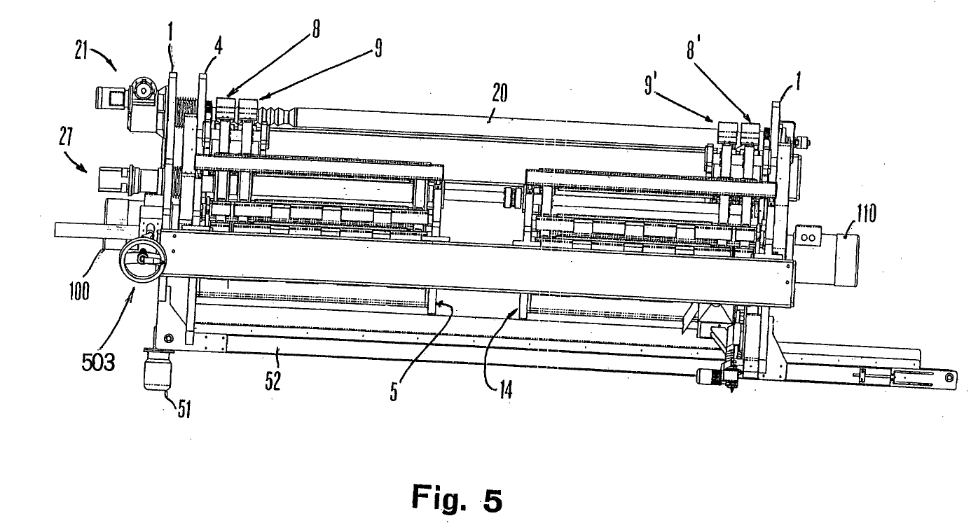

FIG. 5 is a schematic frontal perspective of the device in FIG. 1;

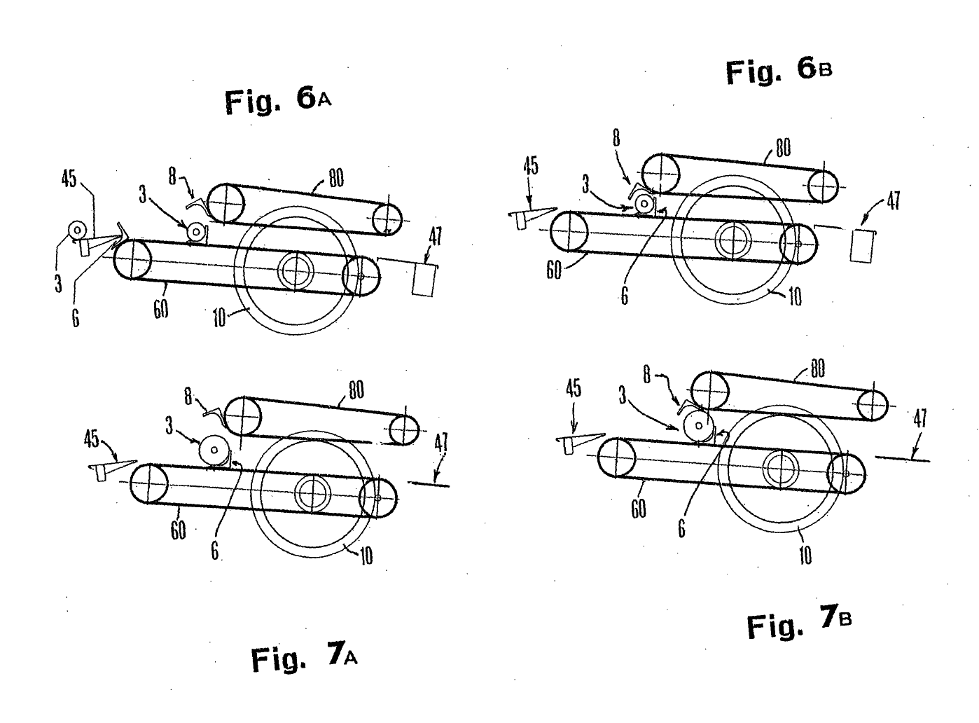

FIGS. 6A-6D are schematic perspectives of four different positions of a log being treated and of the relative guiding and holding guide blades;

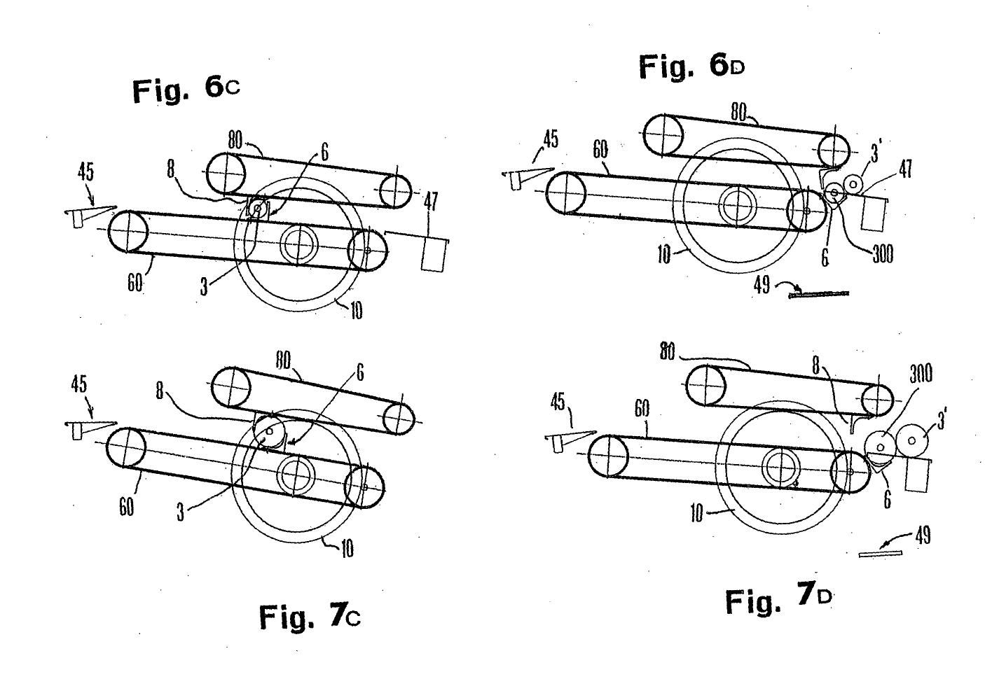

FIGS. 7A-7D are schematic perspectives, as in FIGS. 6A-6D, of four different positions of a log with a greater diameter and of the relative guiding and holding guide blades;

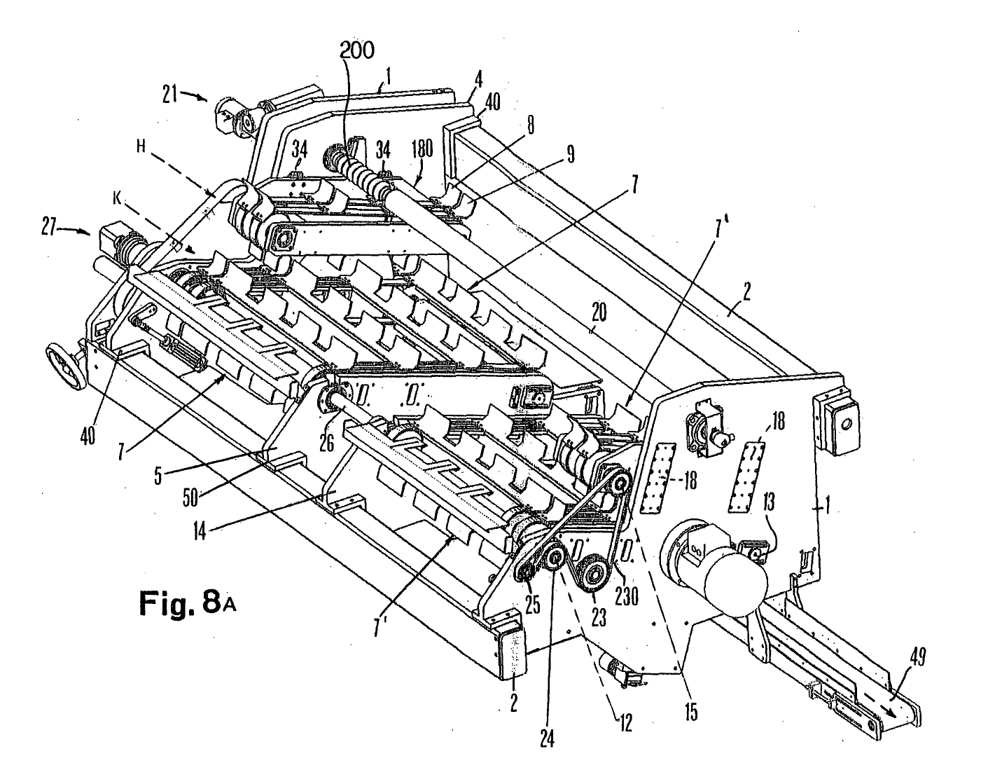

FIG. 8A is a schematic front-lateral perspective of the device in FIG. 1;

FIGS. 8B and 8C are two enlargements of the drawing in FIG. 8A, corresponding, respectively, to the right and left sides;

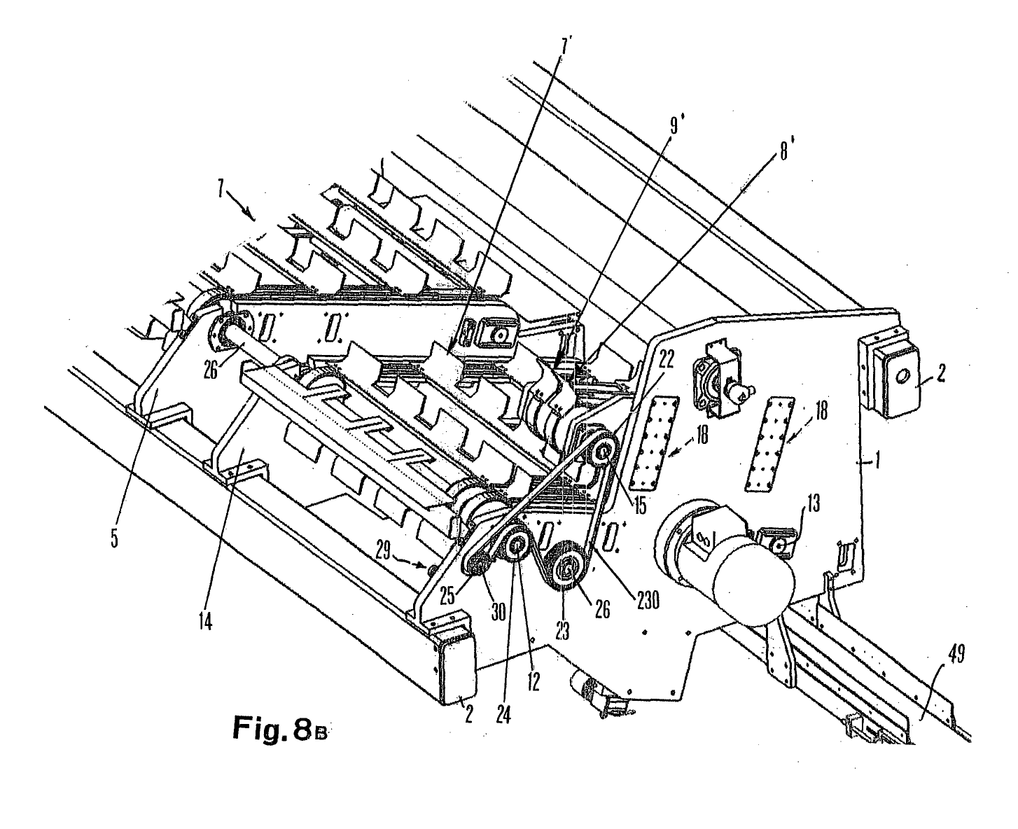

FIG. 9 is a diagram of a frontal view of the guide blades;

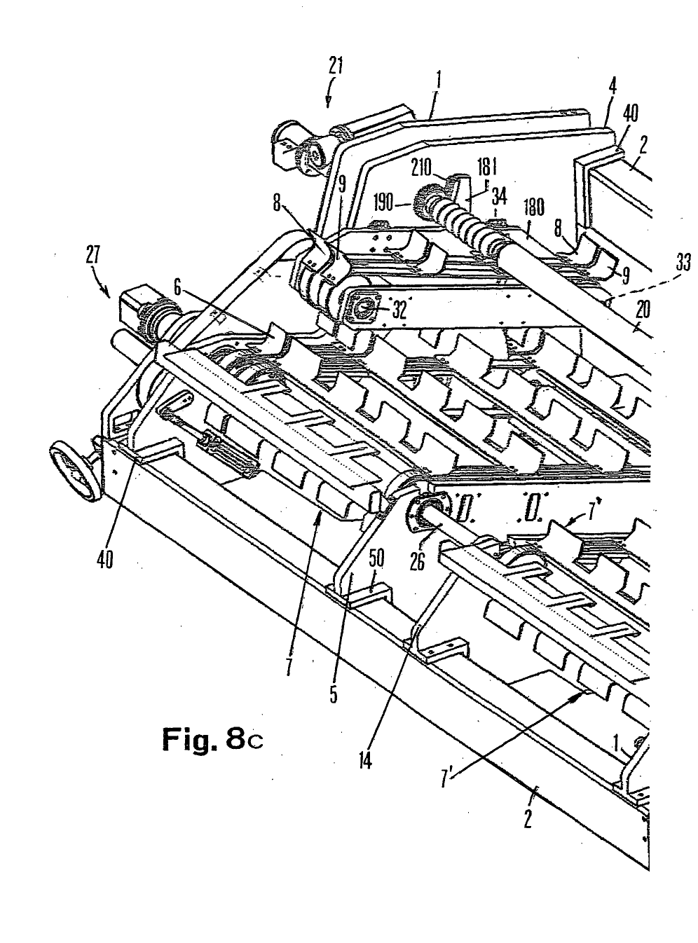

FIG. 10 is a schematic front-lateral perspective of the right side of the device in FIG. 1;

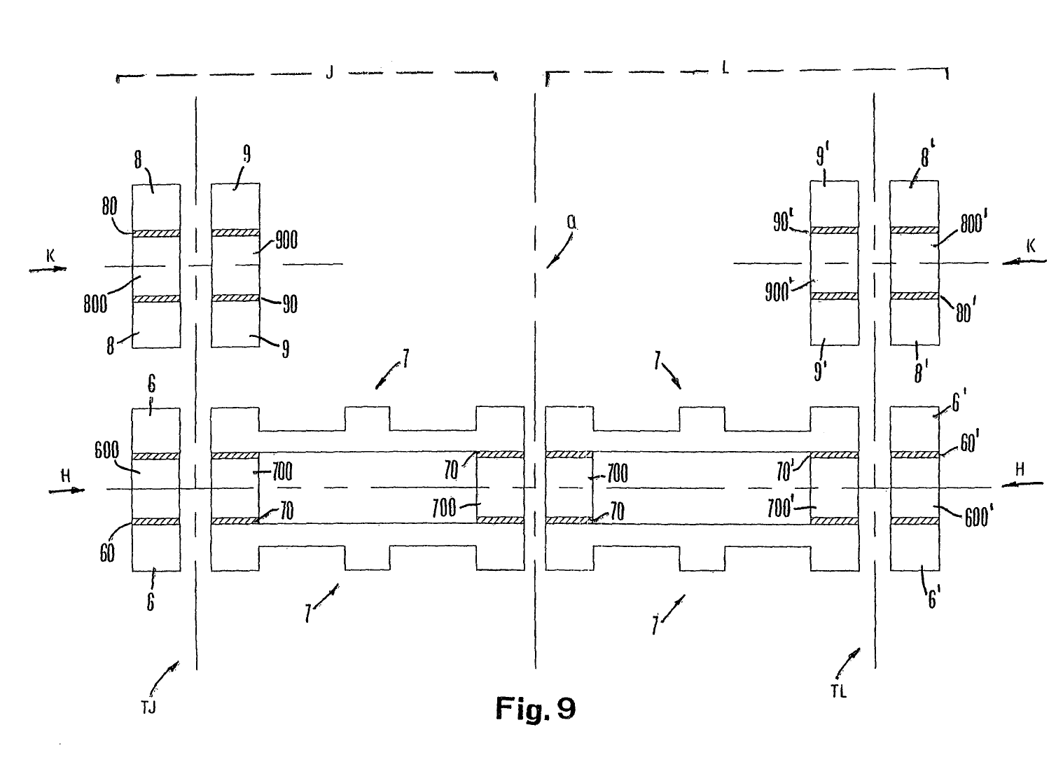

FIG. 11 is a schematic representation of a mechanism for the positioning of the mobile sides (4, 5) in relation to the length of the logs;

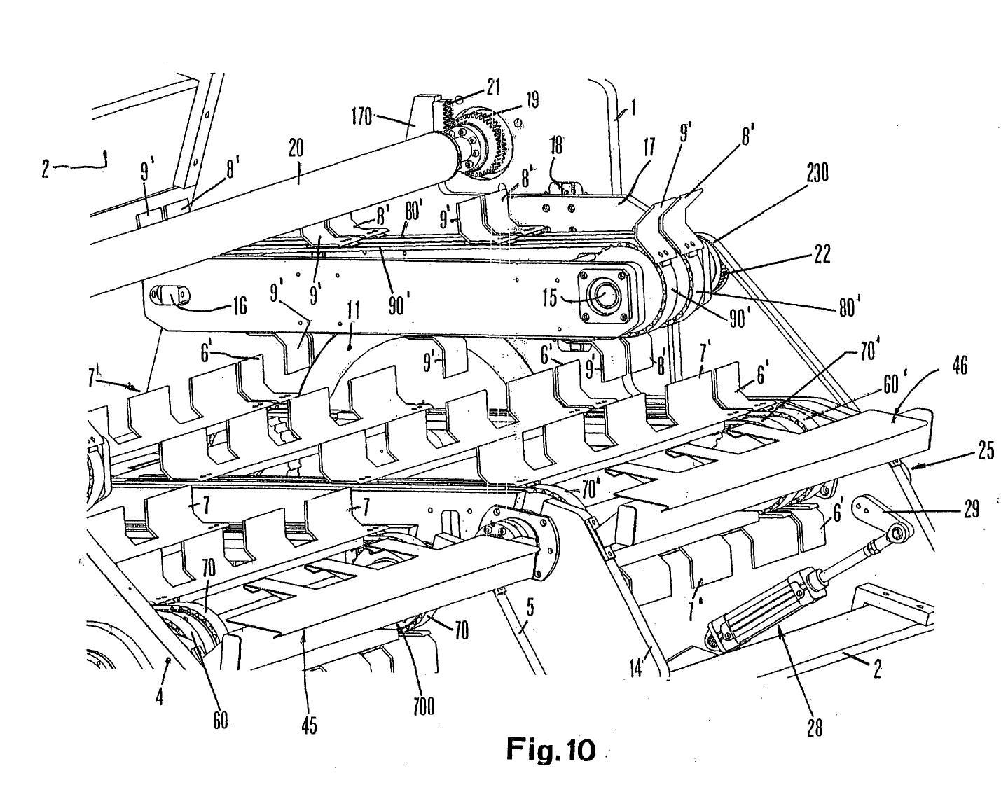

FIG. 12 is a lateral schematic perspective of the coupling joint of the semi-shafts transmitting motion to the pulleys of the first series;

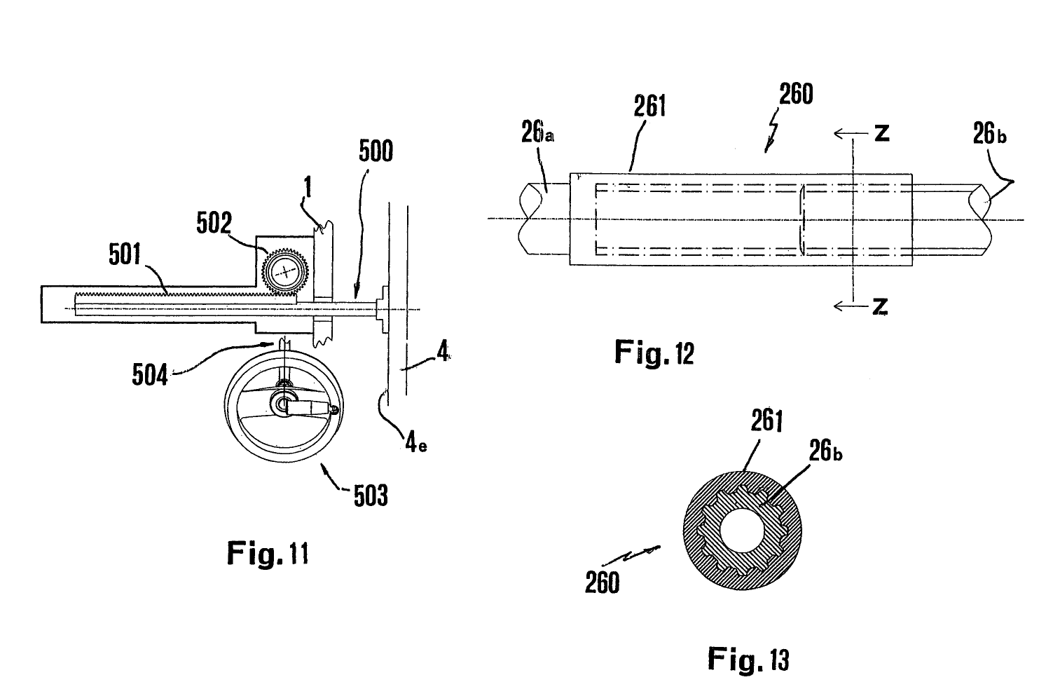

FIG. 13 is a cross-section of FIG. 12 along the Z-Z line.

Reduced to its basic structure, and reference being made to the figures in the attached drawings, a guided handling device, according to the invention, is comprised of:
a fixed structure, defined by two external sides (1) interconnected by two girders (2) of preset length and defining, at their extremities, an entrance front (I) for the logs (3) to be trimmed and an exit front (U) for the trimmed logs (3′).
handling means for moving the logs (3) along an operational path which is developed between said fronts (I, U) of the fixed structure (1, 2);
cutting means disposed and operational in preset points of said path for the logs (3), in order to trim the logs during their motion along said path.

Said handling means for logs are supported, at least in part, by a structure (4, 5) which, in turn, is supported by said fixed structure and interlocked with relative movement means in order to allow it to make a traverse movement parallel to the sides (1) of the fixed structure, that is along the longitudinal development of the girders (2).

In more detail, and with reference being made to the examples shown in the attached drawings, said handling means of logs (3) are comprised of two series (H, K) of “L” shaped guide blades (see FIGS. 8A, 9) further divided into two groups (J, L) so that the guide blades of a same series result disposed on opposite sides of the trajectory followed by each log (3) between the entrance front (I) and the exit front (U), and so that the guide blades of each group (J, L) result disposed on opposite sides of a vertical symmetry plane of the fixed structure (1, 2).

Practically, in the attached drawings, the guide blades (6, 7, 6′, 7′) of the first series (H) are the lower ones, whereas the guide blades (8, 9, 8′, 9′) of the second series (K) are the upper ones.

Moreover, the guide blades (6, 7, 8, 9) of the first group (J) are those to the left of said plane (Q), whereas the guide blades (6′, 7′, 8′, 9′) of the second group (L) are those to the right.

Finally, the guide blades of a same series and of a same group are subdivided into two subgroups set on opposite sides of the action plane of a corresponding cutting blade belonging to said cutting means: the guide blades (6, 7) of the first series (H) and of the first group (J) are on opposite sides of the action plane (TJ) of a first cutting blade (10) intended to provide a corresponding trimming of the incoming logs, as more clearly described below; the guide blades (8, 9) of the second series (K) and of the first group (J) are also on opposite sides of said plane (TJ); the guide blades (6′, 7′) of the first series (H) and of the second group (L) are on opposite sides of the action plane (TL) of a second cutting blade (11) positioned opposite the first blade on the other side of said plane (Q) in order to provide a corresponding trimming of the incoming logs and, analogously, the guide blades (8′, 9′) of the second series (K) and, simultaneously, of the second group (L) are on opposite sides of the action plane (TL) of the second cutting blade (11).

The guide blades (6, 8, 6′, 8′) are external to the cutting planes (TJ, TL), whereas the guide blades (7, 9, 7′, 9′) are internal, that is they are included between these two planes.

The guide blades (6, 7, 8, 9, 6′, 7′, 8′, 9′) are integral with corresponding endless belts (60, 70, 80, 90, 60′, 70′, 80′, 90′) put onto respective drive and snub pulleys (600, 700, 800, 900, 600′, 700′, 800′, 900′): said belts are positioned along the same direction of the path of logs (3) from the entrance front (I) to the exit front (U), and are arranged, analogously to the guide blades being conveyed, into two series (H, K) on opposite sides of the trajectory of logs (3) and into two groups (J, L) on opposite sides of said plane (Q).

Each one of said endless belts is put onto two corresponding pulleys, one driving and the other one idle. According to the example shown in the attached drawings, the drive pulleys are located in the front, that is by the entrance front (I) of the logs (3) to be trimmed, and the idle pulleys are located in the back, that is by the exit front (U) of the trimmed logs (3′). The drive pulleys for the blades (6, 7, 6′, 7′, 8, 9, 8′, 9′) of a same series (H; K) are coaxial. Analogously, the idle pulleys of a same series (H; K) are coaxial.

The diagram in FIG. 9 more clearly shows the position of the guide blades (6, 7, 8, 9, 6′, 7′, 8′, 9′) and of the respective belts (60, 70, 80, 90, 60′, 70′, 80′, 90′) and pulleys (600, 700, 800, 900, 600′, 700′, 800′, 900′) in relation to said planes (TJ), (Q) and (TL).

Each one of said belts (60, 70, 80, 90, 60′, 70′, 80′, 90′) carries a plurality of corresponding guide blades (6, 7, 8, 9, 6′, 7′, 8′, 9′), so that the guide blades on each belt are set at a preset distance from one another.

The guide blades (8, 9, 8′, 9′) of the second series (K) and the guide blades (6, 6′) of the first series (H) external to the cutting planes (TJ, TL) are all of the same width, whereas the guide blades (7, 7′) of the first series (H) are of a greater width and, therefore, they are advantageously mounted onto corresponding pairs of endless belts (70, 70′) put onto respective pairs of pulleys (700, 700′) located at the two extremities of same guide blades (7, 7′).

Moreover, the guide blades (6, 7, 6′, 7′) of the first series (H) are mounted onto respective belts (60, 70, 60′, 70′) in a reverse position compared to the position of the guide blades (8, 9, 8′, 9′) of the second series (K) on the relative belts (80, 90, 80′, 90′).

In more detail, the guide blades (8, 9, 8′, 9′) of the second series (K) are mounted onto corresponding belts so that, when passing through the space covered by the logs (3), the respective concavities face the exit front (U) of the trimmed logs (3′), whereas the guide blades (6, 7, 6′, 7′) of the first series (H) are mounted onto corresponding belts so that, when passing through said space, the respective concavities face the entrance front (I) of the logs (3) to be trimmed.

In other words, the guide blades (6, 7, 6′, 7′) of the first series (H) are mounted onto the respective belts (60, 70, 60′, 70′) so as to result specular to the guide blades (8, 9, 8′, 9′) of the second series (K). In such way, as shown in FIG. 2 and as described in more detail below, the logs (3) to be trimmed, while covering the space defined by the two series (H. K) of guide blades (6, 7, 8, 9, 6′, 7′, 8′, 9′), are blocked by the latter in diametrically opposite multiple points (X, Y), and are thus conveyed and carried by the same guide blades towards the blades (10, 11) and beyond, until, after being trimmed, they are released.

The pulleys (600′, 700′) of the guide blades (6′, 7′) belonging to the first series (H) and to the second group (L) (the guide blades in the lower right corner in the diagram in FIG. 9) are mounted onto two corresponding parallel shafts (12, 13) with each axis of rotation at a preset distance from one another and oriented orthogonally to the pulleys (600′, 700′). On one side, said shafts (12, 13) are supported by the corresponding external side (1) of the fixed structure (1, 2), and, on the other side, they are supported by the fixed internal side (14) of the same structure.

Said internal side (14) is parallel to the external sides (1) of the structure (1, 2) and may be used as datum point to define said plane (Q), which virtually separates the guide blades (6, 7, 8, 9, 6′, 7′, 8′, 9′) into two groups (J, L).

The pulleys (800′, 900′) of the guide blades (8′, 9′) belonging to the second series (K) and to the second group (L) (the guide blades in the upper right corner) are assembled onto two corresponding parallel shafts (15, 16) with each axis of rotation at a preset distance from one another and oriented orthogonally to the pulleys (800′, 900′). Said shafts (15, 16) are cantilevered by a corresponding plate (17) set next to the external right side (1) of the structure (1, 2): the plate (17) is bound to said side (1) by means of two vertical guides (18) and is connected to means of vertical movement which allow movement to and from the underlying guide blades (6′, 7′) of the first series (H) in relation to the diameter of the logs (3) to be treated (see FIG. 10).

Said movement means of the plate (17) are comprised of, as shown in the example in the attached drawings, a pinion (19) mounted onto a respective and appropriately motorized shaft (20), engaging with a rack (21) integral with a vertical appendix (170) of the plate (17): the rotation of the shaft (20) in a direction or in the other determines the approach of the plate (17), and thus of the corresponding guide blades (8′, 9′), to the underlying guide blades (6′, 7′) of the same group (L) and of the first series (H), or, vice versa, their distancing from the same.

FIG. 1 and FIG. 8 show an electrical gearmotor (21) interlocking with said shaft (20). Said gearmotor (21) is supported, in a fixed position, by the external left side (1) of the fixed structure (1, 2). The shaft (20) is supported by the two external sides (1) of the structure (1, 2), between which it extends transversely above the guide blades (6, 7, 8, 9, 6′, 7′, 8′, 9′), without interfering with the trajectory of the latter.

The shaft (15), onto which the front pulleys (800′, 900′) of the guide blades (8′, 9′) are fitted, is equipped with a pulley (22) and an endless serrated belt (230) put onto the same pulley (22) and three other pulleys (23, 24, 25) set below, that is, about at the same height of the guide blades of the first series (H), one guide blade (23) being fitted onto the extremity of a shaft (26) interlocked with a respective motor (27), another one (24) being fitted onto the extremity of a shaft (12) onto which the front pulleys (600′, 700′) of the guide blades (6′, 7′) of the first series (H) and of the second group (J) are mounted, and the third one (25) being joined to a pneumatic tightener (28) by means of a lever (29).

The latter is located on the internal face of the corresponding side (1) of the structure (1, 2) and is connected to the pulley (25) by means of a shaft (30), orthogonally traversing the same side (1): said tightener (28) is located, like the lever (29), on the internal face of said side (1).

The pulleys (22, 23, 24, 25), on which the belt (230) is put, are located on the external face of said side (1) (external right side in the attached drawings).

FIG. 1 shows a protection carter (31) enclosing said pulleys (22, 23, 24, 25) and being attached to the external face of the right side (1).

The guide blades (6, 7, 8, 9) of the first group (J) are supported by the internal mobile sides (4, 5) in the same way as those (6′, 7′, 8′, 9′) of the second group are supported by the fixed sides (1) and (14).

In more detail, the pulleys (600, 700), on which the belts (60, 70) with the guide blades (6, 7) of the first series (H) and of the first group (J) are put, are fitted on said driving shaft (26), which traverses the internal mobile sides (4) and (5). The latter, set at a fixed and preset distance from one another, rest on the girders (2) of the fixed structure (1, 2) by means of corresponding sliding blocks (40, 50) and interlock with corresponding means suited to control their traverse to and from the fixed internal side (14) in relation to the length of the logs (3) to be treated.

Said first cutting blade(10) interlocks with an electrical motor (100) which, as more clearly illustrated in the diagram in FIG. 3, is supported by the mobile side (4) so as to result in an external position in relation to the path followed by the guide blades (6, 7, 8, 9) of the first group (J).

Said second cutting blade (11) interlocks with a corresponding electrical motor (110) which is supported by the right side (1) of the fixed structure (1, 2) so as to result in an external position in relation to the path followed by the corresponding guide blades (6′, 7′, 8′, 9′) of the second group (L).

As stated above, the sides (4) and (5) are mobile. In more detail, said sides are rigidly connected to one another and interlocked with relative movement means, which allow appropriate positioning of said sides in relation to the length of the logs to be treated. Such movement means are comprised of, as shown in the construction example in the attached drawings, a horizontal rod (500) fastened to the external face (left side 4e in the detail in FIG. 11) of the mobile side (4) and equipped with a rack (501) connected to a corresponding pinion (502), which is controlled by a control wheel (503). The latter is positioned on the side (on the left in the attached drawings) of the entrance front (I) of the logs (3) to be trimmed and is directly connected to the pinion (502) be means of a corresponding connection shaft (504). Therefore, the clockwise and counterclockwise rotation of the control wheel (503) causes the corresponding rotation of the pinion (502) and, consequently, the movement to the left or right of the rod (500), which, correspondingly, pulls the mobile sides (4, 5), together with the guide blades (6, 7, 8, 9) of the first group (J), to the left or pushes them to the right, in as much as such guide blades, with their respective conveying means (60, 70, 80, 90), are supported by the mobile sides (4) and (5). And, since the motor (100) is supported by the side (4), when the latter is moved, the motor (100) and its respective cutting blade(10), which always remains between the guide blades (6, 8) and (7, 9), that is always remains within the plane (TJ) defined above, also move along with it. Moreover, said shaft (26) is made of two coaxial portions (26a, 26b) which are connected to each other by means of a grooved joint (260) allowing the reciprocal distancing and approaching of the two portions (26a, 26b), which, independently of distance, always remain connected to one another. In FIGS. 12 and 13 of the attached drawings, said joint (260) is shown in more detail. The latter is made of a sleeve (261), which is fitted onto the free end of the left portion (26a) of the shaft (26) and internally grooved. Multiple longitudinal teeth on the free end of the other portion (26b) of the shaft (26) are engaged in the internal grooves of said sleeve (261). The shape of the longitudinal teeth of the portion (26b) corresponds to the shape of the internal grooves of the sleeve (261). Said shaft (20) is made in the same way, with two coaxial semi-shafts, connected to one another by means of a joint, covered by a cap (200) in the attached drawings, of the same type as described above in reference to the shaft (26). In such way, when the mobile sides (4, 5) are moved to the right (for the treatment of shorter logs), correspondingly, the shafts (20) and (26) are shortened, without impinging upon the movement of the sides. Analogously, when the mobile sides (4, 5) are moved to the left (for the treatment of longer logs), consequently, the shafts (20) and (26) are lengthened.

The pulleys (800, 900) of the upper guide blades (8, 9) belonging to the first group (J) are fitted onto respective shafts (32, 33) cantilevered by a plate (180) set next to the mobile left side (4): the plate (180) is bound to said mobile side (4) by means of two vertical slide ways (34) and interlocks with means of vertical movement which allow the movement to and from the underlying guide blades of the first series (H), in relation to the diameter of the logs (3) to be treated. Said movement means are comprised of, as shown in the example in the attached drawings, a pinion (190) mounted onto said shaft (20) interlocked with a rack (210) integral with a vertical appendix (181) of the plate (180).

Practically, said plates (17) and (180) are identical: the plate (17) is bound to the external right side (1), whereas the plate (180) is bound to the mobile left side (4).

The shaft (35), onto which the front pulleys (800, 900) with the guide blades (8, 9) of the second series (K) and of the first group (J) are fitted, is equipped with a pulley (36) and an endless serrated belt (37) put onto the same pulley (36) and three other pulleys (38, 39, 42) set below, that is, about at the same height of the guide blades of the first series (H), one guide blade (38) being fitted onto a corresponding extremity of said shaft (26), another one (39) being fitted onto the extremity of a shaft (41) onto which the pulleys (600, 700) of the underlying guide blades (6, 8) are mounted, and the third one (42) being joined to a hydraulic tightener (43) by means of a lever (44). The latter is located on the internal face of said side (4) and is connected to the pulley (42) by means of a shaft (400), orthogonally traversing the same side (4). The tightener (43) is located, like the corresponding lever (44), on the internal face of said side (4,), that is on the face of the side (4) facing the mobile side (5). Said pulleys (36, 38, 39, 42) are instead located on the external face of the side (4).

In conclusion, the guide blades (6, 7, 8, 9) of the first group (J) may be moved closer to or further apart from the guide blades (6′, 7′, 8′, 9′) of the second group (L) (in the example, by means of the traverse of the mobile sides 4, 5 along the girders 2), in relation to the length of the logs (3).

Moreover, the guide blades (8, 9, 8′, 9′) of the second series (K) may be closer to the guide blades (6, 7, 6′, 7′) of the first series (H), or further apart, in relation to the diameter of the logs (3).

The conveying of all the guide blades is made possible by the motor (27) that puts into rotation all the respective front pulleys (600, 700, 800, 900, 600′, 700′, 800′, 900′) by means of the belts (37) and (230).

When the plates (17, 180), supporting the groups of guide blades (8, 9) and (8′, 9′) of the second series (K), are raised (during this phase the motor 27 is deactivated), and since the belts (37, 230) are supported by the fixed pulleys (39, 38, 23, 24) as well as by the shafts of the front pulleys (800, 900, 800′, 900′), the pulleys (36) and (22), simultaneously, also rotate (clockwise) and, therefore, the respective guide blades (8, 9, 8′, 9′) move backwards.

Vice versa, when the rotation of the shaft (20) is such that it forces said plates (17, 180) into a lower position, since the tighteners (28) and (43) exert a downwards pull on the pulleys (42, 25) with which they interlock, the shafts of said pulleys (800, 900, 800′, 900′) are correspondingly made to rotate (counterclockwise) and, therefore, the respective guide blades (8, 9, 8′, 9′) of the second series (K) move forwards.

In such way, that is due to the combined movements of raising (lowering) and moving backwards (moving forwards) of the guide blades (8, 9, 8′, 9′) of the second series (K), the entire apparatus makes an effective and precise adjustment to the diameter of the logs (3) to be treated, which, while being cut by the blades (10) and (11), are always in contact both with the guide blades of the first series (H) and with the guide blades of the second series (K).

In correspondence of the entrance front (I) of the logs (3), two planes (45, 46) are set, along which the logs (3) roll, after arriving from a feed system (already known and, therefore, not described in further detail). In more detail, one of said planes (45) is integral with the mobile sides (4, 5), and the other (46) is integral with the fixed sides (1) and (14). In addition, two corresponding planes (47, 48) are set in correspondence of the exit front (U) of the trimmed logs (3′).

As shown in the attached drawings, said planes (45, 46, 47, 48) correspond to the guide blades (6, 7, 6′, 7′) of the first series (H) and exhibit a plurality of appendices oriented towards the same guide blades (6, 7, 6′, 7′). The length of the exit planes (47, 48) corresponds to the length of the guide blades (7, 7′) of the first series (H) included between the cutting planes (TJ, TL). Said guide blades (7, 7′) are interrupted in correspondence of the appendices on the entrance and exit planes (45, 46, 47, 48) of the logs, so that they may traverse the logs without interference, that is so that the transit of the guide blades in correspondence of the planes is unobstructed.

Below the guide blades (6, 7, 6′, 7′) of the first series (H), that is in correspondence of and below the space between said guide blades and the exit planes (47, 48) of the trimmed logs (3′), means to collect and remove the trim ends (300), resulting from the operation, are disposed and functional. As shown in the example in the attached drawings, said means are comprised of an endless belt (49) put onto two corresponding axles set on a sub-structure (52) integral with the external sides (1) of said fixed structure (1, 2) and interlocked with a corresponding electric motor (51). Both said belt (49) and the sub-structure (52) are parallel to the girders (2) of the fixed structure (1, 2) and are set into motion by the relative motor (51), so that the trim ends (300), which fall thereon, are removed (in reference to the drawings, the forward direction of the belt 49 is indicated by a broken line arrow).

The device described above functions as follows. Firstly, in relation to the length and diameter of logs (3), the position of the mobile sides (4, 5) and of the plates (17, 180) is adjusted by bringing the mobile sides (4, 5) closer to or further apart from the internal fixed side (14), in relation to the length the logs (3), and by lowering or raising the plates (17, 180), in relation to the diameter of the logs (3). Then the motors (100, 110) of the blades (10, 11) and the motor (27), which controls the movement of all the guide blades (6, 7, 8, 9, 6′, 7′, 8′, 9′) by means of the shaft (26), are set into motion. As the logs (3) arrive onto the entrance planes (45, 46), they first come into contact with the guide blades (6, 7, 6′, 7′) of the first series (H) and then they are engaged, on the diametrically opposite side, by the upper guide blades (8, 9, 8′, 9′) of the second series (K), thus, they are made stable and transported throughout the zone of action of the blades (10, 11), and then they are released by the same guide blades and dropped onto the exit planes (47, 48).

Since the logs (3), during the trimming phase, are thus guided and blocked by the guide blades (6, 7, 8, 9, 6′, 7′, 8′, 9′), the trimming results of the maximum precision. The trim ends (300), produced in correspondence of the blades (10, 11), come into contact with the guide blades (6, 8, 6′, 8′) which are external to the cutting planes (TJ, TL), and, since the removal planes (47, 48) extend exclusively below the guide blades (7, 9, 7′, 9′) included between said cutting planes, and the trimmed logs (3′) are directed to the removal planes (47, 48), the trim ends (300) fall onto the underlying belt (49), which carries them away from the device.

Advantageously, as more clearly visible in the diagrams in FIG. 2 and FIG. 4, the belts (60, 70, 60′, 70′) with the guide blades (6, 7, 6′, 7′) of the first series (H) are longer than the belts (80, 90, 80′, 90′) with the guide blades (8, 9, 8′, 9′) of the second series (K), so that, in correspondence of the entrance front (I) of the logs (3), there is an empty space above the guide blades (6, 7, 6′, 7′) of the first series (H), that is a space unobstructed by the trajectory of the guide blades of the second series (K).

The above description makes clear that the means for the handling of logs also block and hold the logs along said path, without having to rely on supplementary blocking members, which would be distinctly separate from the handling means, thus eliminating any difficulty related to the relative control of such specific members during the handling of logs.

Practically, the construction details may vary in any equivalent way as far as the shape, dimension, disposition of elements, nature of the used materials are concerned, without nevertheless departing from the scope of the adopted solution idea and, thereby, remaining within the limits of the protection granted to the present patent.

1. Device for the handling of logs, especially within a trimming machine, comprising handling means for logs along a path developed between an entrance section of the logs to be trimmed and an exit section of the trimmed logs, with blades set along said path and intended to provide the trimming of the logs, said handling means of logs also constituting means of holding or blocking the logs along said path, characterized in that said handling and blocking means of logs are comprised of two series of guide blades set on opposite sides of the path followed by logs, said two series of guide blades being subdivided into a first and a second group set on opposite sides of a vertical plane, so that the guide blades of a same series and of a same group form two subgroups of guide blades which are set on opposite sides of the cutting plane of a corresponding blade, said guide blades being mounted onto respective conveying means along said path followed by the logs, and the guide blades of each series engaging the logs diametrically opposite the guide blades of the other series.

2. Device, according to claim 1, characterized in that, at least in correspondence of said blades, said guide blades block the logs both externally and internally to said cutting planes.

3. Device, according to claim 1, characterized in that said conveying means with the guide blades are made of endless belts put onto corresponding pulleys which are assembled onto respective shafts interlocked with a corresponding motor.

4. Device, according to claim 1, characterized in that the guide blades of the second series are set onto respective mobile supports allowing the adjustment of distance from the guide blades of the logs to be treated.

5. Device, according to claim 1, characterized in that the guide blades of the first group may be moved closer to or further apart from the guide blades of the second group in relation to the length of the logs to be treated.

6. Device, according to claim 1, characterized in that the guide blades of said second series and the guide blades of said first series external to the cutting planes are all of the same width, whereas the guide blades of the first series included between the cutting planes, are of a greater width than the others.

7. Device, according to claim 1, characterized in that each of said guide blades exhibits a concavity, in that the guide blades of the second series are mounted onto the corresponding belts so that, when they result in the space traveled by the logs, the respective concavities face towards the exit front of the trimmed logs, and in that the guide blades of said first series (H) are mounted onto the corresponding belts so that, when they result in said space, the respective concavities face towards the entrance front of the logs to be trimmed.

8. Device, according to claim 1, characterized in that said second group of guide blades is integral with a fixed structure comprising of two fixed sides and connected to each other by girders, and in that said first group of guide blades is integral with a structure which is mobile in relation to the fixed one, resting on the girders and interlocked with movement means which control its traverse movement parallel to the same girder on which it rests.

9. Device, according to claim 1, characterized in that, during the phase in which the guide blades of said second series move closer to or further apart from the guide blades of the first series, the guide blades of the second series consequently move forwards or backwards.

10. (canceled)
